(19) United States
(12) Patent Application Publication
(10) Pub. No.: US 2004/0230470 A1
(43) Pub. Date: Nov. 18, 2004

(54) Marketing forecasting tool using econometric modeling

(75) Inventors: Michael Svilar, Silver Spring, MD (US); Christoph R. Loeffler, Delray Beach, FL (US)

Correspondence Address: OPPENHEIMER WOLFF & DONNELLY, LLP (ACCENTURE), PLAZA VII, SUITE 3300, 45 SOUTH SEVENTH STREET, MINNEAPOLIS, MN, 55402-1609, US

(73) Assignee: Accenture Global Services GmbH, Schaffhausen (CH)

(21) Appl. No.: 10/767,661

(22) Filed: Jan. 29, 2004

Related U.S. Application Data
(60) Provisional application No. 60/443,923, filed on Jan. 30, 2003.

(51) Int. Cl. G06F 17/60

(52) U.S. Cl. 705/10

(57) ABSTRACT

One may use econometric techniques to quantify the marketing drivers of consumer demand, retail-load adjustments, and shipments. A customized software tool may analyze the impact of marketing activities on future sales by forecasting consumer demand and retail-load adjustments for a product or service, based upon past results. Dynamic regression or other econometric modeling techniques may be applied to historical marketing spend or sales data to calculate the quantifiable impact of each marketing element on consumer demand and retail load adjustments. Future marketing spending by product and marketing element may be used to perform what-if analysis and determine impacts of marketing spending on forecasted consumer demand and the shipments needed to fulfill consumer demand combined with anticipated retail-load adjustments. Actual consumer demand and shipments may be tracked to highlight and assess forecast errors. Reports for demand forecast errors and shipment forecast error may be generated, with potential error reasons logged.

### FIELD OF THE INVENTION

The invention relates to a system and method for forecasting consumer demand of a product or service. More particularly, the invention relates to a system and method that applies econometric techniques to historical marketing spend data and historical spend data to determine an impact of elements marketing the product or service.

### BACKGROUND OF THE INVENTION

Merchants, in particular retailers of goods, attempt to maintain an inventory supply that is sufficient to accommodate consumer demand yet not maintain a large surplus. Typically, merchants estimate a needed inventory supply using, for example, an educated guess based on prior sales of a particular product, time of year, etc. These are rather rudimentary methods of determining a needed inventory. Additionally, these methods may not take into consideration how marketing materials, for example, coupons, radio and/or television commercials, flyers, etc., may affect a demand for a particular product or service. Even if these methods take marketing into consideration, the method typically do not use a systematic approach, rather, an educated guess method may be used.

Furthermore, these methods typically do not enable a merchant to maintain a record of variances in product or service demand and reasons for the variances. These and other drawbacks exist with current systems.

### SUMMARY OF THE INVENTION

The invention relates to a system and method for using econometric techniques to quantify the marketing drivers of consumer demand, retail-load adjustments, and shipments. The invention includes a customized software tool that assists businesses to analyze the impact of marketing activities on future sales by forecasting consumer demand, retail-load adjustments, and shipments for a particular product or service based upon past results. The tool helps businesses to better forecast shipments based upon marketing spending by calculating the relative effect of each element of a marketing plan using econometric modeling. The tool applies dynamic regression, or other econometric modeling techniques to analyze historical marketing spend data and historical sales data to calculate the quantifiable impact of each marketing element on consumer demand and retail load adjustments. The elements of the marketing plan may include promotions, advertising, points of distribution, product changes, etc. that may be offered to consumers. By forecasting how each marketing element may affect consumer demand and retail-load adjustments, a business may evaluate how to better forecast shipments based upon its marketing spending.

The tool may also be used to directly forecast shipments. Econometric modeling techniques may be used to analyze historical marketing spend data and historical shipments to calculate the quantifiable impact of each marketing element directly on shipments.

The tool enables the user to input future marketing spending by product and marketing element. This enables the user to perform what-if analysis and determine the impact of the marketing spending on forecasted consumer demand and required shipments.

The tool may also be used to capture and track actual consumer demand and shipments to highlight and assess forecast errors. Detailed reports may be generated that indicate demand forecast error and shipment forecast error. The detailed reports may be generated according to a time period, product, etc. Users may document potential reasons for demand forecast errors and shipment forecast errors. The potential reasons for errors in the demand forecast and shipment forecast may be maintained in a log. The log may be used to keep a record of the demand and shipment forecast errors to reduce a likelihood of repeating these errors.

### BRIEF DESCRIPTION OF THE DRAWINGS

These and other features, aspects, and advantages of the present invention will become better understood with reference to the following description, appended claims, and accompanying drawings where:

FIG. 1 is a block diagram of a method for analyzing marketing activity according to one embodiment of the invention.

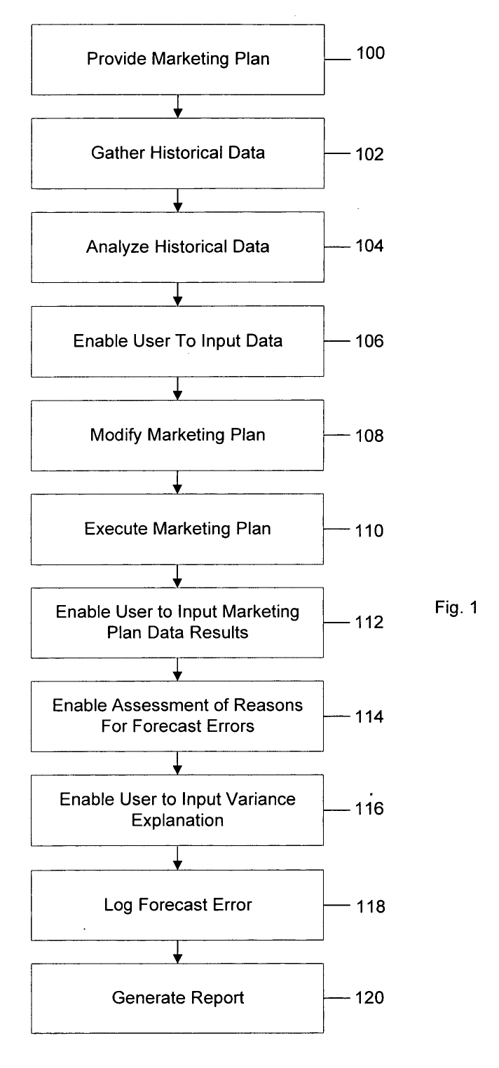

FIG. 2 is a block diagram of a system for analyzing marketing activity according to one embodiment of the invention.

FIG. 3 is an image of an input screen of a system for analyzing marketing activity according to one embodiment of the invention.

### DETAILED DESCRIPTION OF THE PREFERRED EMBODIMENTS

The invention relates to a system and method for using econometric techniques to quantify the marketing drivers of consumer demand, retail-load adjustments, and shipments. The retail-load adjustments may be retail demand for a product or service generated by future sales incentives, new product launches or other factors which motivate retailers to carry extra stock.

According to one embodiment of the invention, a marketing plan that includes at least one marketing element may be provided by a business, step 100. The marketing element may be, for example, promotions, advertising, points of distribution, product changes, etc. Historical marketing spend data and historical sales data may be gathered to determine the correlation of past marketing activities on sales and retail load adjustments, step 102. Preferably, data is collected for at least the past twenty-four (24) reporting periods (e.g., months). Regression analysis or other econometric modeling techniques may be performed to calculate the effect of marketing variables on consumer demand and retail load adjustments, step 104.

A lift coefficient may be assigned to each variable and may be used to forecast future consumer demand, anticipated retail load adjustments, and total shipments. The total shipments may be defined as a sum of consumer demand and anticipated retail-load adjustments. The marketing forecasting tool enables users to enter planned marketing spend amounts for each marketing variable to forecast consumer demand and required shipments, step 106.

According to one embodiment, regression analysis or other econometric modeling techniques may be used to directly forecast shipments based on marketing spending rather than modeling the effects on consumer demand and retail load adjustments to build up the shipment forecast. In these instances, econometric modeling techniques may be used to analyze historical marketing spend data and historical shipments to calculate the quantifiable impact of each marketing element directly on shipments.

Econometric modeling has been used by others to explain why certain circumstances have occurred. However, the present invention now uses econometric modeling as a forecasting tool—looking forward rather than backward. Shipment data has also be leveraged by others for various purposes. However, prior uses of shipment data has used exponential smoothing and other techniques. The present invention now uses econometric modeling on shipment data since it can show how business decisions drive changes in shipments beyond standard sales activities. One embodiment of the invention is able to forecast approximately two months into the future. A second embodiment is able to forecast a full year into the future. When forecasting on an annual basis, other various factors may be used as part of the econometric modeling step, where such factors are particularly well suited for such longer term forecasting.

According to one embodiment of the invention, the business may evaluate what-if scenarios and adjust the planned spend on various marketing elements based upon their impact on the forecasts, step 108. For example, the marketing plan for a particular product may include one-hundred-thousand dollars ($100,000) on coupons delivered via electronic mail, five-hundred-thousand dollars ($500,000) on advertising, and two-hundred-fifty-thousand ($250,000) on promotions. The tool may be used to determine what effect on consumer demand and required shipments may result if changes are made to any of the marketing spend values. For example, performing what-if analysis using the tool may indicate that promotions have the largest impact on consumer demand and shipments whereby a one (1) percent increase in spending on promotions may increase demand for the product by twelve (12) percent. Using what-if analysis, the business may decide how to shift more dollars in the marketing plan to promotional spending from the other marketing elements.

The marketing plan may be executed, step 110. The resulting consumer demand and shipment data may be captured and entered into the tool to determine the accuracy of the forecast, step 112. This enables the forecasted demand and actual demand to be tracked and compared. The results may provide a percentage by which the consumer demand and shipments were forecasted above or below actual demand.

The tool may be used to enable a user to perform an assessment to identify the reasons for any variances between the consumer demand and shipment forecasts and the actual results, step 114. For example, it may be found that while the marketing plan called for $100,000 to be spent on coupons, only $50,000 was spent resulting in reduced customer demand. The tool may enable a user to enter explanations for any of the variances, step 116. The explanations for the variances and the forecast errors may be logged, step 118. A report that indicates the forecasted demand, actual demand, and explanation for variances may be generated, step 120. A manager or other business personnel may analyze the report to determine whether operational changes are required to generate future results that better resemble the forecast.

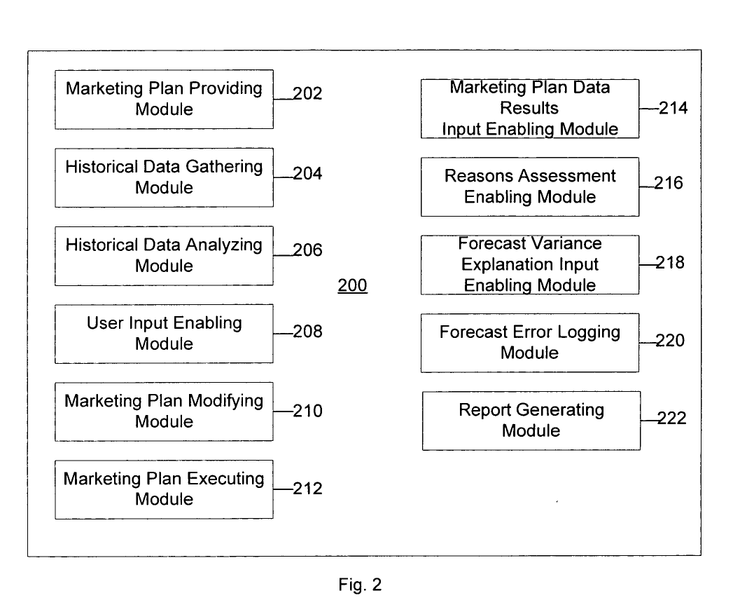

FIG. 2 illustrates a system 200 for analyzing marketing activity effects on shipments according to one embodiment of the invention. Oftentimes, shipments may be indicated as a function of consumer demand and retail-load adjustments. The system 200 may include a marketing plan providing module 202. The marketing plan providing module 202 may be used to provide one or more marketing plans. The marketing plans may include delivering marketing offers to one or more customers via one or more marketing elements. A historical data gathering module 204 may be used to gather historical marketing spend data and sales data to determine a correlation of past marketing activities on sales and retail-load adjustments. The historical data may be analyzed using historical data analyzing module 206. The historical data analyzing module 206 preferably applies various econometric modeling techniques to calculate the effect of marketing variables that represent marketing elements.

A lift coefficient may be associated with each marketing variable and may be used to forecast future consumer demand, retail load adjustments, and thus, total shipments. In some cases, the lift coefficients may directly correlate the marketing spending to the total shipments as described above.

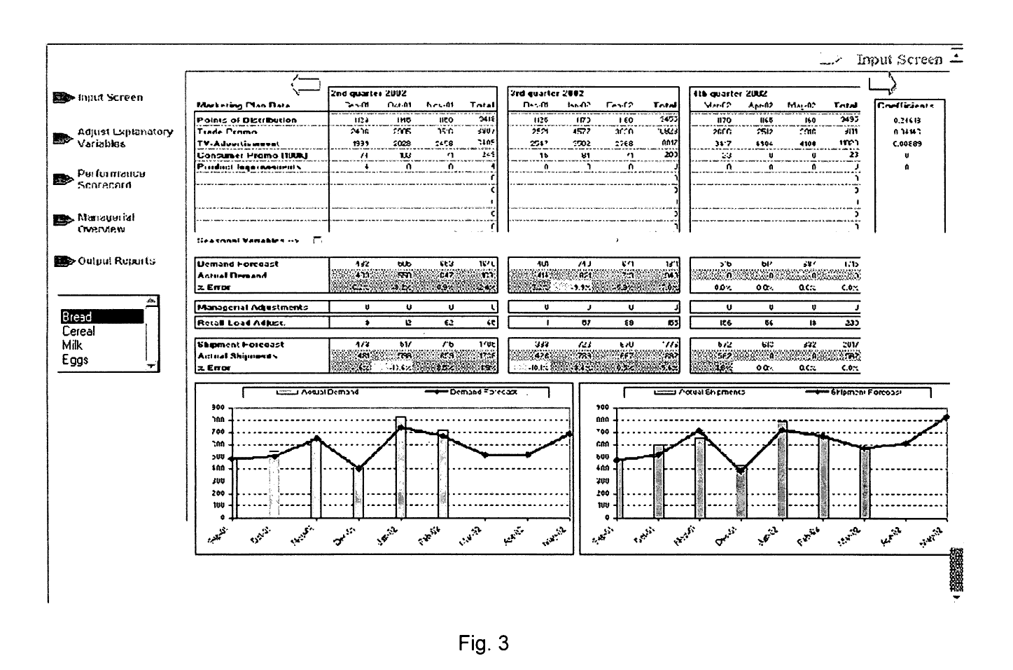

The system 200 may enable the user to input how much money may be spent on particular marketing elements of the marketing plan using a user input enabling module 208 as shown in FIG. 3. FIG. 3 is a representation of an input screen that may be used for detailing forecasted demand and shipments and assessing and tracking forecast variances. According to one embodiment of the invention, a user may execute what-if scenarios to evaluate the effect on consumer demand and required shipments when changes are made to the planned spend on particular marketing elements in the marketing plan. A marketing plan modifying module 210 may be used to modify the marketing plan based upon the results of the what-if analysis.

A marketing plan executing module 212 may be used to execute the marketing plan. This may include, for example, delivering one or more marketing offers to consumers via regular mail, electronic mail, facsimile, telephone call, etc. A marketing plan data results inputting module 214 may be used to input the consumer demand and shipment data into the system 200 to determine the accuracy of the forecast. This enables the forecasted demand and actual demand to be compared. The accuracy of the forecast may be indicated by a percentage by which the consumer demand and shipments were forecasted above or below the actual demand. A reasons assessing module 216 may be used to perform an assessment and to identify reasons for any differences between forecasted and actual consumer demand and shipments.

The system 200 may also be used to enable a user to enter explanations regarding any of the differences using a forecast variance explanation input enabling module 218. The explanations for the forecast variances as well as the forecast errors may be logged using a forecast error logging module 220. A report that indicates the forecasted demand, actual demand, and explanation for variances may be generated using a report generating module 222. A manager or other business personnel may analyze the report to determine whether operational changes are required to generate future results that better resemble the forecast.

While the specification describes particular embodiments of the present invention, those of ordinary skill can devise variations of the present invention without departing from the inventive concept.

What is claimed is:

1. A method for using econometric techniques to quantify marketing drivers and forecast at least one of consumer demand and shipments comprising:
providing at least one marketing plan, wherein the at least one marketing plan comprises at least one marketing element;
using econometric modeling to quantify the effect of marketing elements on shipments; and
forecasting at least one of consumer demand and shipments in response to the at least one marketing plan and results of the econometric modeling.

2. The method of claim 1, wherein the shipments are defined by at least one of consumer demand and anticipated retail load adjustments.

3. The method of claim 1, further comprising determining at least one of demand forecast error and shipment forecast error.

4. The method of claim 1, further comprising calculating a lift parameter of the at least one marketing element.

5. The method of claim 1, further comprising generating at least one report that indicates at least one of consumer demand forecast error, and shipment forecast error.

6. The method of claim 1, further comprising enabling a user to input marketing spend data and the at least one marketing element.

7. The method of claim 1, wherein the at least one marketing element comprises at least one of promotions, advertising, points of distribution and product changes.

8. The method of claim 1, further comprising modifying the at least one marketing plan based on the forecasting.

9. The method of claim 1, further comprising capturing reasons for forecast errors.

10. The method of claim 9, further comprising tracking the reasons for the forecast errors.

11. The method of claim 10, wherein the reasons for the forecast errors are tracked with the forecast errors.

12. The method of claim 1, further comprising executing the at least one marketing plan.

13. A system for using econometric techniques to quantify marketing drivers and forecast at least one of consumer demand and shipments comprising:
a providing module that provides at least one marketing plan, wherein the at least one marketing plan comprises at least one marketing element;
a quantifying module that uses econometric modeling to quantify the effect of marketing elements on shipments; and
a forecasting module that forecasts at least one of consumer demand and shipments in response to the at least one marketing plan and results of the econometric modeling.

14. The system of claim 13, wherein the shipments are defined by at least one of consumer demand and anticipated retail load adjustments.

15. The system of claim 13, further comprising a determining module that determines at least one of demand forecast error and shipment forecast error.

16. The system of claim 13, further comprising a calculating module that calculates a lift parameter of the at least one marketing element.

17. The system of claim 13, further comprising a generating module that generates at least one report that indicates at least one of consumer demand forecast error, and shipment forecast error.

18. The system of claim 13, further comprising an enabling module that enables a user to input marketing spend data and the at least one marketing element.

19. The system of claim 13, wherein the at least one marketing element comprises at least one of promotions, advertising, points of distribution and product changes.

20. The system of claim 13, further comprising a modifying module that modifies the at least one marketing plan based on the forecasting.

21. The system of claim 13, further comprising a capturing module that captures reasons for forecast errors.

22. The system of claim 21, further comprising a tracking module that tracks the reasons for the forecast errors.

23. The system of claim 22, wherein the reasons for the forecast errors are tracked with the forecast errors.

24. The system of claim 13, further comprising an executing module that executes the at least one marketing plan.
